(19) United States
(12) Patent Application Publication
(10) Pub. No.: US 2026/0231931 A1
(43) Pub. Date: Aug. 13, 2026

(54) CLOMAZONE MICROCAPSULES

(71) Applicant: CALYXIA, BONNEUIL-SUR-MARNE (FR)

(72) Inventors: Quentin BLANGEARD, BONNEUIL SUR MARNE (FR); Alexandre BROSSE, BONNEUIL SUR MARNE (FR); Nancy SOLIMAN, BONNEUIL SUR MARNE (FR); Maxime HEBERT, BONNEUIL SUR MARNE (FR); Shimon AMSELEM, ASHDOD (IL)

(21) Appl. No.: 19/151,946

(22) PCT Filed: Jan. 31, 2024
(86) PCT No.: PCT/EP2024/052416

§ 371 Date: Jul. 29, 2025

(30) Foreign Application Priority Data
Jan. 31, 2023 (EP) 23305126.7

(51) Int. Cl. A01N 25/28; A01N 43/80; A01P 13/00

(52) U.S. Cl. CPC A01N 25/28; A01N 43/80; A01P 13/00

(57) ABSTRACT

The present invention relates to a solid cross-linked microcapsule encapsulating clomazone having a mean diameter from 3 μm to 30 μm, said microcapsule comprising: —a core consisting of a composition C1 comprising clomazone, and —a solid cross-linked polymer envelope totally encapsulating the core at its periphery, said solid cross-linked polymer envelope being made of a biodegradable cross-linked polymer, said polymer being an aliphatic polymer obtained by polymerizing one or several oligomer(s) or monomer(s), said polymer comprising at least 25%, preferably at least 30%, of ester groups by weight in comparison with the total weight of said polymer, and wherein the average thickness of said solid cross-linked polymer envelope is from 5% to 30% of the average diameter of said solid cross-linked microcapsule.

The present invention concerns clomazone microcapsules, as well as plant protection compositions comprising said microcapsules and weeding methods using said compositions.

Clomazone (2-(2-chlorophenyl)methyl-4,4-dimethyl-3-isoxazolidinone) is a highly effective herbicide that is selective against perennial weeds, including grasses and broadleaves. Clomazone works by inhibiting the biosynthesis of carotenoids in the plant, resulting in progressive whitening with increased dosage. Herbicides containing clomazone are applied to the soil for control of weeds on beans, cabbage, cucumbers, cotton, melons, mint, peas, peppers, rice, soybeans, squash, sugarcane, sweet potatoes, tobacco or tuberous vegetables.

Clomazone is volatile. When applied on the soil, under certain conditions clomazone may migrate or diffuse to adjacent areas, causing whitening or bleaching of beneficial plants near the treated fields. Accordingly, the label for the use of clomazone-containing herbicides lists some restrictions on how the herbicide is to be used, including weather conditions, spray volume and pressure, droplet size, and distance from areas where plants are in commercial production.

Microencapsulated formulations of clomazone have been developed to address the problem of clomazone's volatility. Various methods of microencapsulating clomazone are disclosed in U.S. Pat. Nos. 5,583,090; 5,597,780; 5,783,520; 6,380,133; 6,440,902; and U.S. Patent Publication No. 2010/0234225. Even existing microencapsulated formulations of clomazone are limited in the clomazone concentration they can achieve, and in their ability to create formulations in which other active ingredients are microencapsulated with the clomazone.

Until now, clomazone is mostly encapsulated through the use of surfactants. Furthermore, many encapsulation systems rely on the use of polyisocyanates in the polymer shell, which have a high degree of toxicity and therefore should be avoided in agricultural production for foodstuff. Toxicity is mainly due to the large amount of urethane polymers, which cannot be biologically broken.

The aim of the present invention is thus to provide microcapsules encapsulating clomazone that simultaneously reduce the volatility of clomazone, and control its release rate over an extended time period.

Another aim of the present invention is to provide microcapsules encapsulating clomazone capable of assuring that the release will not be instantaneous upon spray application but rather extended over a desired time period.

Another aim of the present invention is to provide microcapsules encapsulating clomazone, with improved biodegradability properties, allowing to reduce their environmental impact and ensure compliance with bans on the intentional use of microplastics.

Therefore, the present invention relates to a solid cross-linked microcapsule encapsulating clomazone having a mean diameter from 3 μm to 30 μm, said microcapsule comprising:
a core consisting of a composition C1 comprising clomazone, and
a solid cross-linked polymer envelope totally encapsulating the core at its periphery,
   said solid cross-linked polymer envelope being made of a biodegradable cross-linked polymer, said polymer being an aliphatic nonaromatic polymer obtained by polymerizing one or several oligomer(s) or monomer(s), said polymer comprising at least 25%, preferably at least 30%, of ester groups by weight in comparison with the total weight of said polymer,
   and wherein the average thickness of said solid cross-linked polymer envelope is from 0.5 μm to 10 μm or from 5% to 30% of the average diameter of said solid cross-linked microcapsule.

According to the invention, the terms “aliphatic” and “nonaromatic” are used indifferently.

Consequently, the present invention addresses the particular case of encapsulation of clomazone, a highly volatile active, whose controlled release is critical to its use in agricultural production. Moreover, the biodegradability of the capsule shell reduces its environmental impact and ensures compliance with bans on the intentional use of microplastics.

The present invention improves the existing microencapsulated formulations of clomazone by providing a formulation that simultaneously reduces the volatility of clomazone, controls its release rate over an extended time period, assures that the release will not be instantaneous upon spray application but rather extended over a desired time period, and is furthermore encapsulated in a biodegradable shell and, if necessary, a biodegradable core additive. The microcapsules of the invention have additionally proven greater efficacy than their commercial references.

In the present application, the terms «microcapsules» and «capsules» are used indifferently.

The solid microcapsules have a core and a solid envelope (or shell) fully encapsulating the core on the periphery thereof, wherein the core consists of a composition C1 comprising clomazone.

Preferably, these solid microcapsules are formed of a core containing clomazone (composition C1) and a solid envelope (or shell) (obtained from a specific polymer) fully encapsulating said core on the periphery thereof.

As mentioned above, the microcapsules are solid cross-linked microcapsules.

The term “shell” refers to a solid cross-linked polymer envelope that has a roughly spherical shape. The function of a shell (or envelope), as used in a microcapsule, is to keep the encapsulated material found within the shell generally separate from the material outside of the microcapsule. The shell (or envelope) is diffusible so that under appropriate conditions it will allow diffusion into or out of the microcapsule to occur.

The term “core” of a microcapsule refers to the encapsulated composition located within the shell. The core of the microcapsules according to the invention is made of a composition C1 comprising clomazone as active agent.

According to the present invention, the term “solid” refers to the non-liquid, cross-linked polymer.

According to the present invention, the term “cross-linked” refers to a polymer bond being formed between two or more oligomers.

The microcapsules according to the invention have a mean diameter as defined above, said diameter being measured by methods well known to the skilled person in the art, e.g. by a light scattering technique (for example using a Mastersizer 3000 equipped with a hydro SV measuring cell), or by image analysis of optical microscopy pictures, or by image analysis of electronic microscopy pictures.

### Composition C1

Composition C1 comprises clomazone as explained above. This composition C1 acts as carrier for clomazone, both within the droplets formed during the method of the invention and in the solid capsules obtained.

According to an embodiment, composition C1 is monophasic i.e. it is the clomazone alone or it is a solution comprising clomazone in solubilized form.

In one embodiment, clomazone is solubilized in composition C1.

In this variant, composition C1 is typically composed of a solution of clomazone in an aqueous solution or organic solvent, or a mixture of organic solvents, clomazone being contained in a weight content of between 1% to 99% relative to the total weight of composition C1. Clomazone may be contained in a weight content of between 5% to 95%, 10% to 90%, 20% to 80%, 30% to 70% or 40% to 60% relative to the total weight of composition C1.

In one embodiment, composition C1 consists of clomazone.

In another embodiment of the invention, composition C1 is a biphasic composition, which means that clomazone is dispersed either in liquid form or in solid form in composition C1 and is not fully solubilized in said composition C1.

According to an embodiment, the composition C1 further comprises a viscosifying agent and/or a biodegradable carrier oil.

This embodiment reduces the volatility of clomazone by encapsulating it in a polymer shell with a high cross-link density, and may further include the formulation of a core capsule comprising a biodegradable oil and viscosifying agent that limits the diffusion of clomazone into the shell polymer.

According to an embodiment, the composition C1 further comprises a viscosifying agent. This agent may also be named “rheology modifying agent”.

According to a preferred embodiment, the composition C1 further comprises from 1% to 20%, preferably from 1% to 15%, and more preferably from 1% to 10%, by weight of a viscosifying agent relative to the total weight of said composition C1.

According to the invention, the term “viscosifying agent” refers to a compound that increases the viscosity of the medium to which it is added, preferably obtaining a viscosity of at least 1000 mPa·s, more preferably at least 2000 mPa·s and most preferably above 10,000 mPa·s.

Such agent is thus able to improve the viscosity of the composition C1 containing the clomazone. A higher viscosity reduces the volatility of clomazone from the capsule by limiting the diffusion of clomazone into the polymer envelope as defined above.

Preferably, the viscosifying agent is selected from the group consisting of: fumed silica, clay, organic polymers such as hydrogenated vegetable oils, and hydrogels such as polysaccharides or hydrophilic silicates.

According to a preferred embodiment, the viscosifying agent is fumed silica.

According to an embodiment, the composition C1 further comprises a biodegradable carrier oil.

According to a preferred embodiment, the composition C1 further comprises from 5% to 40% by weight of a biodegradable carrier oil relative to the total weight of said composition C1.

More preferably, the composition C1 comprises from 5% to 30% by weight of a biodegradable carrier oil relative to the total weight of said composition C1.

According to the invention, the term “biodegradable carrier oil” refers to an oil in which clomazone is miscible, which is furthermore biodegradable as defined by OECD Test 301.

Preferably, the biodegradable carrier oil is selected from the polyester oils.

As preferred polyester oils, one may cite the one that are liquid at ambient temperature (from 20° C.-50° C.), and that have a boiling point above 60° C.

The biodegradable carrier oil according to the present invention has preferably a viscosity at room temperature comprised from 20 mPa·s to 5,000 mPa·s, preferably from 200 mPa·s to 5,000 mPa·s.

As preferred carrier oils, one may cite unsaturated polyol esters such as, by way of example, DEHYLUB® 4038 from EmeryOleo.

Alternatively, natural oils can be used as the biodegradable carrier oil, including soybean oil, linseed oil, jojoba oil, corn oil, castor oil and/or combinations thereof.

According to a preferred embodiment, the composition C1 as defined above comprises from 20% to 60%, preferably from 30% to 60%, by weight of clomazone relative to the total weight of said composition C1.

### Polymer Envelope

In one embodiment, the above-mentioned solid microcapsules comprise a solid shell that is entirely composed of crosslinked polymer. This polymer may also be named copolymer or be a (co)polymer network.

The microcapsules according to the invention comprise a shell or envelope as defined above that is made of a biodegradable cross-linked polymer, said envelope being obtained by polymerizing one or several oligomer(s) or monomer(s), said envelope being thus made of an aliphatic (or nonaromatic) polymer resulting from the polymerization of said oligomers or monomers, said polymer comprising a minimum of 25%, preferably a minimum of 30%, of ester groups, by weight in comparison to the total weight of said polymer.

In the invention, the term «monomer», «oligomer» or «polymer» designates any base unit adapted for the formation of a solid material via polymerization, either alone or in combination with other monomers or polymers. The term «polymer» also encompasses oligomers.

The average thickness of the polymer envelope as defined above is measured by optical microscopy, wherein a collection of capsules is observed through an optical microscope and the image is recorded digitally. Standard digital tools available to a person skilled in the art of microscopy such as ImageJ can be utilized to determine the thickness of the polymer envelope based on the contrast between the envelope and core. A minimum of 10 and preferably a minimum of 20 microcapsules can be analyzed in this manner to obtain an average value.

Throughout the present application, biodegradability is defined herein as the ability to degrade in a natural medium such as defined in OECD standards: OECD 301 (Ready biodegradability), namely OECD 301 A (Dissolved Organic Carbon (DOC) Die-Away), OECD 301 B (CO₂ Evolution), OECD 301 C (Modified MITI (I) test), OECD 301 D (Closed Bottle test), OECD 301 E (Modified OECD Screening), OECD 301 F (Manometric Respirometry test), or further in OECD 304A (Inherent Biodegradability in Soil), OECD 306 (Biodegradability in Seawater) and OECD 310 (Ready Biodegradability—CO₂ in Sealed Vessels), and OECD NF T 51800 (Compostable products definition).

The following examples of polymers may be mentioned:

The suitability of the microcapsule for encapsulation of clomazone is connected to certain attributes of the capsule, such as its core composition and the chemistry of the shell. In particular, controlling the core viscosity by controlling the composition of the core enables an improved retention of clomazone. Furthermore, the chemistry of the capsule shell also has an impact on the retention of clomazone. In particular, the percentage of ester groups in the shell and the molecular weight of the spacers are parameters that may have an impact on the retention of clomazone. The spacer is defined as the distance between the ester groups in the final polymer shell (or envelope).

According to an embodiment, the polymer envelope comprises an aliphatic (or nonaromatic) (co)polymer network of one or more oligomer(s) or monomer(s) comprising at least 25% weight of ester groups, preferably at least 30% weight, in relation to the total weight of said polymer. The primary component of the network can be referred to as M1 (or oligomer M1) and the secondary component can be referred to as M2 (monomer or oligomer M2). The distinction between M1 and M2 is for example the molecular weight. Preferably, the molecular weight of M1 is from 1,500 to 10,000 g/mol and the molecular weight of M2 is from 50 to 1,500 g/mol.

According to a preferred embodiment, the aliphatic (or nonaromatic) polymer of the solid cross-linked polymer envelope is obtained by polymerizing one or several oligomer(s) or monomer(s) M1 and M2, the molecular weight of M1 being from 1,500 to 10,000 g/mol and the molecular weight of M2 being from 50 to 1,500 g/mol, said oligomers M1 and M2 comprising preferably at least one reactive function selected from the group formed by acrylate, methacrylate, vinyl ether, N-vinyl ether, epoxy, siloxane, amine, lactone, phosphate and carboxylate functions, which react to bind the oligomers (e.g. polyester oligomers) together.

Preferably, the shell (or envelope) chemistry is defined through the minimal percentage of ester groups in the shell, which has a high influence on the cross-linking density of said shell. It will be clear to a person skilled in the art that the selection of the oligomers and monomers that are contained in the envelope determines the value of the average molecular weight of the spacer between the cross-links (or ester groups). The spacer between the cross-links can be defined as a chain between two ester groups. To produce capsules comprising said polymer network in the shell, the raw materials can be selected using the fact that this value can be calculated by determining the average of the ratio of the molecular weight of the oligomer/(number of reactive function(s)−1)*% in the pre-polymerized oligomer(s) M1 and M2. The value can also be determined experimentally from the final polymerized solid envelope in the following manner: acid hydrolysis can be used to break down the ester bonds after which a chemical analysis of the molecular weight of the constituents between each ester bond can be performed using methods known to a person skilled in the art such as size exclusion chromatography (SEC) or TOF-SIMS. SEC may be carried out with a Waters 510 HPLC pump equipped with three columns from Polymer Labs, Inc., having 5 μm bead size (two with MIXED-D and one 50 Å pore sizes). THF can be used as the eluent. Such a measurement system is typically equipped with a Waters R401 differential refractometer as the detector. Typically the weight fraction distribution as a function of molecular weight can be determined, which provides a value for the distance between the ester bonds in the polymer envelope.

The reactive functions as mentioned above in M1 and/or M2 are preferably selected from the group formed by acrylate, methacrylate, vinyl ether, N-vinyl ether, epoxy, siloxane, amine, lactone, phosphate and carboxylate functions.

The influence of selection of pre-polymerized oligomers on the percentage of ester groups in the final solid polymerized shell also plays a role in the properties of the capsule and its performance. The selection of oligomers M1 and M2 can be optimized by tailoring the selection thereof to achieve a minimum of 25% weight of ester groups.

The percentage of ester groups in a polymerized shell is the ratio between the weight of ester groups present in the shell and the weight of total polymer shell material. One can determine this value from the pre-polymerized oligomers M1 and M2 with the following formula:

$${\sum }_{oligomers i} {f}_{i} \frac{{n}_{ester i}}{{M}_{wi}} {M}_{Wester}$$

where:
   the sum considers all oligomers irrespective of their type M1 or M2,
   fᵢ is the number percentage of oligomer i in the shell material,
   n_{ester i} is the sum of the number of ester groups and reactive functions that subsequently become an ester group after cross-linking within oligomer I,
   M_{wi} is the molecular weight of oligomer I, and
   M_{w ester} is the molecular weight of an ester group.

Furthermore, the % ester groups can also be determined experimentally from the final polymerized solid envelope in the following manner: using solid nuclear magnetic resonance methods, by which the ester atoms have a specific resonant frequency, which can be compared to the resonant frequency of the atoms in a carbon-carbon bond through a ratio between the two, the ratio thereof thereby providing a percentage of the ester groups in the total molecular structure of the shell. In particular the peak observed using ¹³C MAS NMR, at 180 ppm is characteristic of an ester bond, whereas a C—H bond is characterized by a peak at 30 ppm. Solid state ¹³C MAS-NMR proton decoupling single-pulse spectra of polymers can be obtained with a Bruker Avance DRX-400 spectrometer using a magnetic field of 9.36 T and equipped with a multinuclear probe. The measurement conditions are preferably as follows: Minced samples are packed in 4 mm Ø zirconia rotors and spun at 10 KHz. The spectra are acquired at a frequency of 100.61 MHz, using a π/6 pulse width of 2.5 μs and a pulse space of 10 s to ensure full relaxation and to allow quantitative analysis from peak areas. Such methods are detailed in for instance Benftez, Jose & Heredia-Guerrero, José & Guzman-Puyol, Susana & Barthel, Markus & Dominguez, Eva & Heredia, Antonio. (2015). “Polyhydroxyester Films Obtained by Non-Catalyzed Melt-Polycondensation of Natural Occurring Fatty Polyhydroxyacids.” Frontiers in Materials. 2. 10.3389/fmats.2015.00059.

Among the examples of such oligomers for M1, the following compounds and mixtures thereof may be mentioned: the family of aliphatic esters and polyesters particularly comprising polyglycolides (PGAs), polylactides (PLAs), poly(lactide-co-glycolide) (PLGAs), poly(ortho esters) e.g. polycaprolactone (PCL), polydioxanone, poly(ethylene succinate), poly(butylene succinate) (PBS), poly(ethylene adipate), poly(butylene adipate), poly(ethylene sebacate), poly(valerolactone) (PVL), poly(decalactone), polyhydroxyvalerate, poly(beta-malic acid), poly-3-hydroxybutyrate (PHB), poly-3-hydroxy-butyrate-co-3-hydroxyvaldrate (P-3H B-3HV), poly-3-hydroxybutyrate-co-4-hydroxybutyrate (P-3H B-4H B), poly-3-hydroxybutyrate-co-3-hydroxyvalerate-co-4-hydroxybutyrate (P-3HB-3HV-4HB), poly (3-hydroxyvalerate), poly(3-hydroxypropionate), poly (3-hydroxycaproate), poly (3-hydroxyoctanoate), poly(3-hydroxydecanoate), poly(3-hydroxyundecanoate), poly(3-hydroxydodecanoate), poly(3-hydroxybutyrate-co-3-hydroxyvalerate), poly(3-hydroxy butyrate-co-3-hydroxydecanoate), poly(3-hydroxybutyrate-co-3-hydroxypropionate), poly(3-hydroxybutyrate-co-3-hydroxyoctanoate), poly(3-hydroxyheptanoate), poly(3-hydroxyhexanoate), poly(2-hydroxybutyrate), poly(3-hydroxybutyrate-co-4-hydroxy-butyrate), poly(3-hydroxybutyrate-co-3-hydroxyhexanoate), poly(3-hydroxybutyrate-co-3-hydroxyhexanoate), poly(4-hydroxybutyrate), poly(4-hydroxybutyrate-co-2-hydroxybutyrate), poly(4-hydroxypropionate), poly(4-hydroxyvalerate), poly(5-hydroxybutyrate), poly(5-hydroxyvalerate), poly(6-hydroxyhexanoate), poly(alkylene alkanoate), poly(alkylene dicarboxylate), poly(butylene adipate), poly(butylene carbonate), poly(butylene pimelate), poly(butylene succinate), poly(butylene succinate-co-adipate), poly(butylene succinate-co-carbonate), poly(butylene sebacate), poly(butylene succinate-co-lactate), polydiaxanone, poly(ethylene azelate), poly(ethylene carbonate), poly(ethylene decamethylate), poly(ethylene furanoate), poly(ethylene oxalate), poly(ethylene succinate), poly(ethylene succinate-co-adipate), poly(ethylene sebacate), poly(ethylene suberate), poly(hexamethylene sebacate), poly(glycolide-co-caprolactone), poly(lactide-co-epsilon-caprolactone), polymandelide, poly (B-malic acid), poly(propylene succinate), poly(tetramethylene carbonate), poly(trimethylene carbonate), poly(tetramethylene succinate)-co-(tetramethylene carbonate), poly(trimethylene adipate), poly(tetramethylene adipate), poly(tetramethyl glycolide), aliphatic poly(urethane) such as polycaprolactone, polycarbonate urethanes, aliphatic urethane diacrylate, aliphatic urethane methacrylate, aliphatic urethane triacrylate, non-isocyanate polyurethanes, poly(valerolactone), additionally carrying at least one reactive function selected from the group formed by acrylate, methacrylate, vinyl ether, N-vinyl ether, epoxy, siloxane, amine, lactone, phosphate and carboxylate functions, which bind the oligomers (e.g. polyester oligomers) together.

Among the examples of oligomers for M2, the following compounds and mixtures thereof may be mentioned: diacrylates e.g. 1,6-hexanediol diacrylate, 1,6-hexanediol dimethacrylate, polyethylene glycol diacrylate, polyethylene glycol dimethacrylate, 1,9-nonanediol dimethacrylate, 1,4-butanediol dimethacrylate, 1,3-butanediol dimethacrylate, 1,10-decanediol dimethacrylate, bis(2-methacryloxyethyl) N,N′-1,9-nonylene biscarbamate, 1,4-butanediol diacrylate, 1,5-pentanediol dimethacrylate, allyl methacrylate, N,N′-methylenebisacrylamide, 2,2-bis[4-(2-hydroxy-3-methacryloxypropoxy)phenyl]propane, tetraethylene glycol diacrylate, diethylene glycol diacrylate, triethylene glycol diacrylate, triethylene glycol dimethacrylate, polyethylene glycol diglycidyl ether, N,N-diallylacrylamide or glycidyl methacrylate; multifunctional acrylates e.g. dipentaerythritol pentaacrylate, 1,1,1-trimethylolpropane triacrylate, 1,1,1-trimethylolpropane trimethacrylate, ethylenediamine tetramethacrylate, pentaerythritol triacrylate or pentaerythritol tetraacrylate; and acrylates also having another reactive function e.g. propargyl methacrylate, N-acryloxysuccinimide, N-(2-Hydroxypropyl) methacrylamide, N-(t-BOC-aminopropyl) methacrylamide, monoacryloxyethyl phosphate, acrylic anhydride, 2-(tert-butylamino) ethyl methacrylate, N,N-diallylacrylamide, N-ethoxy ethyl acrylates, propoxylated N-glyceryl triacrylate or glycidyl methacrylate or ethers and polyethers particularly comprising polyethylene glycols, additionally carrying at least one reactive function selected from the group formed by acrylate, methacrylate, vinyl ether, N-vinyl ether, epoxy, and amine functions and mixtures thereof, which bind the oligomers (e.g. polyester oligomers) together.

According to a preferred embodiment, the solid cross-linked microcapsule according to the invention is devoid of surfactant. Preferably, neither the core nor the envelope comprises any surfactant.

According to a preferred embodiment, the solid cross-linked microcapsule according to the invention further comprises an anionic polyelectrolyte polymer, preferably a lignosulfonate. Preferably, said anionic polyelectrolyte polymer is in the envelope of the microcapsules. Said preferred embodiment improves the dispersion of microcapsules in a liquid slurry.

According to an embodiment, the present invention relates to a solid cross-linked microcapsule as defined above, wherein the solid cross-linked polymer envelope is formed through UV polymerization.

The encapsulation systems in the prior art are based on either interfacial polymerization or coacervation, whereas the present invention preferably uses a double emulsion method that significantly reduces energy consumption and waste produced over the course of capsule production.

Preferably, the solid cross-linked microcapsule is prepared according to the specific process as explained hereafter.

The process for the preparation of a solid cross-linked microcapsule according to the invention may for example comprise the following steps:
a) under stirring, adding a composition C1 comprising clomazone to a polymeric composition C2, compositions C1 and C2 not being miscible with each other, C1 the composition C1 being as defined above, the viscosity of composition C2 being between 500 mPa·s and 100 000 mPa·s at 25° C., and preferably being higher than the viscosity of composition C1, the composition C2 comprising:
   one or several oligomer(s) or monomer(s) M1 and M2 as defined above, and
   at least one photoinitiator or crosslinking catalyst,
      after which an emulsion (E1) is obtained comprising droplets of the composition C1 dispersed in the composition C2;
b) under stirring, adding the emulsion (E1) to a composition C3, compositions C2 and C3 not being miscible with each other,
   the viscosity of composition C3 being between 500 mPa·s and 100 000 mPa·s at 25° C., and preferably being higher than the viscosity of emulsion (E1), after which a double emulsion (E2) is obtained comprising droplets dispersed in composition C3;
c) applying shear to emulsion (E2),
   after which a double emulsion (E3) is obtained comprising droplets of controlled size dispersed in composition C3; and
d) polymerizing composition C2, after which solid cross-linked microcapsules are obtained dispersed in composition C3.

At step a), the composition C1 is added to a crosslinkable polymeric composition C2, this step being conducted under stirring which means that composition C2 is kept under agitation typically mechanically whilst composition C1 is added, to emulsify the mixture of compositions C1 and C2.

Throughout step a), composition C1 is at a temperature of between 0° C. and 100° C., preferably between 10° C. and 80° C., and more preferably between 15° C. and 60° C. Throughout step a), composition C2 is at a temperature of between 0° C. and 100° C., preferably between 10° C. and 80° C., and more preferably between 15° C. and 60° C.

Under the conditions for addition at step a), compositions C1 and C2 are not miscible with each other, which means that the amount (by weight) of composition C1 capable of being solubilized in C2 is equal to or lower than 5%, preferably lower than 1%, and more preferably lower than 0.5% relative to the total weight of composition C2, and that the amount (by weight) of composition C2 capable of being solubilized in composition C1 is equal to or lower than 5%, preferably lower than 1%, and more preferably lower than 0.5% relative to the total weight of composition C1.

Therefore, when composition C1 comes into contact with C2 under agitation, it is dispersed in the form of droplets called single droplets.

The immiscibility between compositions C1 and C2 also allows the prevention of migration of the active ingredient of composition C1 towards composition C2.

Composition C2 is stirred to form an emulsion comprising droplets of composition C1 dispersed in composition C2. This emulsion is also called a «single emulsion» or C1-in-C2 emulsion.

To carry out step a), it is possible to use any type of mixer usually used to form emulsions e.g. a mechanical blade mixer, static emulsifier, ultrasonic homogenizer, membrane homogenizer, high-pressure homogenizer, colloidal mixer, high-shear disperser or high-speed homogenizer.

The volume fraction of C1 in C2 can vary from 0.1 to 0.6 to control the thickness of the shell of the capsules obtained on completion of the method.

In one embodiment, the ratio between the volume of composition C1 and the volume of composition C2 varies between 1:10 and 10:1. Preferably, this ratio is between 1:3 and 5:1, more preferably between 1:3 and 3:1.

Preferably, the viscosity of composition C2 at 25° C. is between 1 000 mPa·s and 300 000 mPa·s, more preferably between 25 000 mPa·s and 250 000 mPa·s, for example it is between 50 000 mPa·s and 25 000 mPa·s.

Preferably, the viscosity of composition C2 is higher than the viscosity of composition C1.

Viscosity is measured using a Haake Rheostress™ 600 rheometer equipped with cone of diameter 60 mm having 2-degree angle, and a temperature control cell set at 25° C. The value of viscosity is determined at a shear rate of 10 s⁻¹.

In this embodiment, the destabilizing kinetics of the droplets of emulsion (E1) are significantly slow, allowing the shell of the microcapsules to be polymerized at step d) before the emulsion become unstable. Polymerization, once completed, then provides thermodynamic stabilization. Therefore, the relatively high viscosity of composition C2 ensures the stability of emulsion (E1) obtained after step a).

Composition C2 contains at least one monomer or oligomer such as defined below, and at least one photoinitiator or crosslinking catalyst, making the composition crosslinkable.

In one embodiment, composition C2 comprises from 50% to 99% by weight of monomer or polymer such as defined below, or a mixture of monomers and polymers such as defined below, relative to the total weight of composition C2.

In one embodiment, composition C2 comprises from 0.1% to 5% by weight of photoinitiator or a mixture of photoinitiators, relative to the total weight of composition C2.

By «photoinitiator» it is meant a compound capable of fragmenting under the effect of light radiation.

The photoinitiators which can be used in the present invention are known in the art and are described for example in “Les photoinitiateurs dans la réticulation des revêtements” (Photoinitiators in the crosslinking of coatings) G. Li Bassi, Double Liaison—Chimie des Peintures, N^{o} 361, November 1985, p. 34-41; “Applications industrielles de la polymerisation photoinduite” (Industrial applications of photoinduced polymerization) Henri Strub, L'Actualité Chimique, February 2000, p. 5-13; and “Photopolymères: considérations théoriques et réaction de prise” (Photopolymers: theoretical considerations and curing reaction), Marc, J. M. Abadie, Double Liaison—Chimie des Peintures, N^{o} 435-436, 1992, p. 28-34.

At step b) of the method of the invention, a second emulsion (E2) is prepared.

The second emulsion is composed of a dispersion of droplets of the first emulsion in a composition C3 immiscible with C2, created through the dropwise addition of emulsion (E1) to C3 under stirring.

Throughout step b), emulsion (E1) is at a temperature of between 15° C. and 60° C. Throughout step b), composition C3 is at a temperature of between 15° C. and 60° C.

Under the conditions for addition at step b), compositions C2 and C3 are not miscible with each other, which means that the amount (by weight) of composition C2 capable of being solubilized in composition C3 is equal to or lower than 5%, preferably lower than 1%, and more preferably lower than 0.5% relative to the total weight of composition C3, and that the amount (by weight) of composition C3 capable of being solubilized in composition C2 is equal to or lower than 5%, preferably lower than 1%, and more preferably lower than 0.5% relative to the total weight of composition C2.

Therefore, when emulsion E1) comes into contact with composition C3 under agitation, it is dispersed in the form of droplets called double droplets, the dispersion of these droplets of emulsion (E1) in the C3 continuous phase being called emulsion (E2).

Typically, a double droplet formed at step b) corresponds to a single droplet of composition C1 such as described above, surrounded by a shell of composition C2 which fully encapsulates said single droplet.

The double droplet formed at step b) may also comprise at least two single droplets of composition C1, said single droplets being surrounded by a shell of composition C2 which fully encapsulates said single droplets.

Therefore, said double droplets comprise a core composed of one or more single droplets of composition C1, and a layer of composition C2 surrounding said core.

The resulting emulsion (E2) is generally a polydisperse double emulsion (C1-in C2-in C3 emulsion, or C1/C2/C3 emulsion), which means that the double droplets do not have a distinct size distribution in emulsion (E2).

The immiscibility between compositions C2 and C3 allows the prevention of mixing between the layer of composition C2 and composition C3, and thereby ensures the stability of emulsion (E2).

The immiscibility between compositions C2 and C3 also allows the prevention of migration of the water-soluble substance of C1 from the core of the droplets towards composition C3.

To implement step b), it is possible to use any type of mixer usually used to form emulsions, e.g. a mechanical blade mixer, static emulsifier, ultrasonic homogenizer, membrane homogenizer, high-pressure homogenizer, colloidal mixer, high-shear disperser or high-speed homogenizer.

The continuous phase C3 may be defined by the selection of a material with optimized viscosity parameters, according to WO2022/117681, that is incorporated herein by reference.

In one embodiment, the composition C3 further comprises one or several water-soluble anionic polyelectrolyte polymer(s). The composition C3 may comprise from 0.01 to 15 mass % of said polymer, preferably from 0.05 to 10 mass % of said polymer, more preferably from 0.1 to 10% of said polymer. In one embodiment, said anionic polyelectrolyte polymer is a lignosulfonate.

In one embodiment, the viscosity of composition C3 at 25° C. is higher than the viscosity of emulsion (E1) at 25° C.

In the invention, the viscosity of composition C3 at 25° C. is between 500 mPa·s and 100 000 mPa·s.

Preferably, the viscosity of composition C3 at 25° C. is between 3 000 mPa·s and 100 000 mPa·s, more preferably between 5 000 mPa·s and 80 000 mPa·s, e.g. between 7 000 mPa·s and 70 000 mPa·s.

In this embodiment, given the very high viscosity of the continuous phase formed by composition C3, the rate of destabilization of the double droplets of emulsion (E2) is significantly slow compared with the duration of the method of the invention, which therefore affords kinetic stabilization of emulsion (E2) and then of (E3) until polymerization of the shell of the capsules is completed. Once polymerized, the capsules are thermodynamically stable.

Therefore, the very high viscosity of composition C3 ensures the stability of emulsion (E2) obtained after step b).

Low surface tension between C3 and the first emulsion as well as high viscosity of the system advantageously allow ensured kinetic stability of the double emulsion (E2), preventing dephasing thereof throughout the production time.

Preferably, the interfacial tension between compositions C2 and C3 is low. This low interfacial tension between compositions C2 and C3 also advantageously allows ensured stability of emulsion (E2) obtained after step b).

The volume fraction of the first emulsion in C3 can be varied between 0.05 and 0.5 first to improve production yield and secondly to vary the mean diameter of the capsules. On completion of this step, the size distribution of the second emulsion is relatively wide.

In one embodiment, the ratio between the volume of emulsion (E1) and the volume of composition C3 varies between 1:10 and 10:1. Preferably, this ratio is between 1:9 and 3:1, more preferably between 1:9 and 1:1.

In one embodiment, the composition C3 further comprises one or several water-soluble anionic polyelectrolyte polymer(s). The composition C3 may comprise from 0.01 to 15 mass % of said polymer, preferably from 0.05 to 10 mass % of said polymer, more preferably from 0.1 to 10% of said polymer. In one embodiment, said anionic polyelectrolyte polymer is a lignosulfonate.

At step c) of the method of the invention, the size of the droplets of the second emulsion (E2) is refined.

At this step, controlled homogeneous shear can be applied to emulsion (E2), said rate of applied shear being between 110 s⁻¹ and 100 000 s⁻¹.

In one embodiment, the polydisperse double droplets obtained at step b) are subjected to size refining whereby they undergo shear capable of fragmenting them into new double droplets of controlled and homogeneous diameter. Preferably, this fragmentation step is performed using a high-shear cell of Couette type following a method described in patent application EP 15 306 428.2.

In one embodiment, at step c), the second emulsion (E2) obtained after step b), composed of polydisperse double droplets dispersed in a continuous phase, is subjected to shear in a mixer which applies controlled, homogeneous shear.

Therefore, in this embodiment, at step c) controlled, homogeneous shear is applied to emulsion (E2), said applied shear rate being between 1 000 s⁻¹ and 100 000 s⁻¹.

In this embodiment, in a mixer, the shear rate is said to be controlled and homogeneous, independently of time length, when it reaches a maximum value that is the same for all the parts of the emulsion at a given instant which can vary from one point of the emulsion to another. The exact configuration of the mixer is not essential according to the invention, provided that the whole emulsion has been subjected to the same maximum shear on leaving this device. Mixers suitable for performing step c) are notably described in U.S. Pat. No. 5,938,581.

The second emulsion can be subjected to controlled, homogeneous shear when it circulates through a cell formed by:
two concentric rotating cylinders (also called Couette-type mixer);
two parallel rotating discs; or
two parallel oscillating plates.

In this embodiment, the shear rate applied to the second emulsion is between 1 000 s⁻¹ and 100 000 s⁻¹, preferably between 1 000 s⁻¹ and 50 000 s⁻¹, and more preferably between 2 000 s⁻¹ and 20 000 s⁻¹.

In this embodiment, at step c), the second emulsion is placed in the mixer and subjected to shear resulting in the formation of the third emulsion. The third emulsion (E3) is chemically the same as the second emulsion (E2) but is composed of monodisperse double droplets whereas emulsion (E2) is composed of polydisperse double droplets. The third emulsion (E3) is typically composed of a dispersion of double droplets comprising a core formed of one or more droplets of composition C1 and of a layer of composition C2 encapsulating said core, said double droplets being dispersed in composition C3.

The difference between the second emulsion and the third emulsion is the size variance of the double droplets: the droplets of the second emulsion are polydisperse in size whereas the droplets of the third emulsion are monodisperse by means of the fragmentation mechanism described above.

Preferably, in this embodiment, the second emulsion is added continuously to the mixer, which means that the amount of double emulsion (E2) fed into the mixer is the same as the amount of third emulsion (E3) leaving the mixer.

Since the size of the droplets of emulsion (E3) essentially corresponds to the size of the droplets of the solid microcapsules after polymerization, it is possible to adjust the size of the microcapsules and the thickness of the shell by adjusting the shear rate at step c), with strong correlation between the reduction in size of the droplets and the increase in shear rate. This makes it possible to adjust the resulting dimensions of the microcapsules by varying the shear rate applied at step c).

In one preferred embodiment, the mixer used at step c) is a mixer of Couette type comprising two concentric cylinders, an outer cylinder of inner radius Rₒ and an inner cylinder of outer radius Rᵢ, the outer cylinder being fixed and the inner cylinder rotating at an angular velocity ω.

A mixer of Couette type adapted for the method of the invention can be supplied by T.S.R. France.

In one embodiment, the angular velocity ω of the rotating inner cylinder of the Couette-type mixer is equal to or higher than 30 rad·s⁻¹.

For example, the angular velocity ω of the inner rotating cylinder of the Couette-type mixer is about 70 rad·s⁻¹.

The dimensions of the outer fixed cylinder of the Couette-type mixer can be chosen to modulate the space (d=Rₒ−Rᵢ) between the inner rotating cylinder and outer fixed cylinder.

In one embodiment, the space (d=Rₒ−Rᵢ) between the two concentric cylinders of the Couette-type mixer is between 50 μm and 1 000 μm, preferably between 100 μm and 500 μm, for example between 200 μm and 400 μm.

For example, the distance d between the two concentric cylinders is 100 μm.

In this embodiment, at step c), the second emulsion is fed into the mixer typically via a pump and is directed towards the space between the two concentric cylinders, the outer cylinder being fixed and the inner cylinder rotating at an angular velocity ω.

When the double emulsion reaches the space between the two cylinders, the shear rate applied to said emulsion is given by the following equation:

$$γ = \frac{{R}_{i} ω}{( {R}_{o} - {R}_{i} )}$$

where:
   ω is the angular velocity of the inner rotating cylinder,
   Rₒ is the inner radius of the outer fixed cylinder, and
   Rᵢ is the outer radius of the inner rotating cylinder.

In another embodiment, when the viscosity of composition C3 is higher than 2 000 mPa·s at 25° C., at step c) a shear rate of less than 1 000 s⁻¹ is applied to emulsion (E2).

In this embodiment, the fragmentation step c) can be performed using any type of mixer usually used to form emulsions at a shear rate lower than 1 000 s⁻¹, in which case the viscosity of composition C3 is higher than 2 000 mPa·s, namely under conditions such as those described in patent application FR 16 61787.

The geometric characteristics of the double droplets formed on completion of this step will dictate those of the future capsules.

In this embodiment, at step c), emulsion (E2) formed of polydisperse droplets dispersed in a continuous phase, is subjected to shear e.g. in a mixer at a low shear rate, namely lower than 1 000 s⁻¹.

In this embodiment, the shear rate applied at step c) is between 10 s⁻¹ and 1 000 s⁻¹ for example.

Preferably, the shear rate applied at step c) is strictly lower than 1 000 s⁻¹.

In this embodiment, the droplets of emulsion (E2) can only be efficiently fragmented into fine, monodisperse droplets of emulsion (E3) if a high shear stress is applied thereto.

The shear stress 6 applied to a droplet of emulsion (E2) is defined as the tangential force per unit surface area of the droplet resulting from the macroscopic shear applied to the emulsion when mixed at step d).

The shear stress σ (expressed in Pa), viscosity of composition C3 η (expressed in Pa s) and shear rate γ (expressed in s⁻¹) applied to emulsion (E2) when mixed at step d) are related by the following equation:

σ=ηγ

Therefore, in this embodiment, the high viscosity of composition C3 allows the application of very high shear stress to the droplets of emulsion (E2) in the mixer, even if the shear rate is low and shear is non-homogeneous.

To implement step c) in this embodiment, it is possible to use any type of mixer usually used to form emulsions, e.g. a mechanical blade mixer, static emulsifier, ultrasonic homogenizer, membrane homogenizer, high-pressure homogenizer, colloidal mixer, high-shear disperser or high-speed homogenizer.

In one preferred embodiment, a simple emulsifier is used such as a mechanical paddle blade mixer or static emulsifier to carry out step c). This is possible since this embodiment does not require either controlled shear or shear greater than 1 000 s⁻¹.

At step d) of the method of the invention, the shell of the solid microcapsules of the invention is crosslinked and hence formed.

This step allows both expected performance levels to be reached for capsule retention and ensured thermodynamic stability thereof, by definitively preventing any destabilization mechanism such as coalescence or maturation.

In one embodiment, when composition C2 comprises a photoinitiator, step d) is a photopolymerization step whereby emulsion (E3) is exposed to a light source able to initiate photopolymerization of composition C2, in particular to a UV light source preferably emitting in the wavelength range of between 100 nm and 400 nm, and in particular for a time of less than 15 minutes.

In this embodiment, at step d) emulsion (E3) is subjected to photopolymerization, which will allow photopolymerization of composition C2. This step will allow the obtaining of microcapsules encapsulating the water-soluble substance such as defined above.

In one embodiment, at step d) emulsion (E3) is exposed to a light source able to initiate photopolymerization of composition C2.

Preferably, the light source is a UV light source.

In one embodiment, the UV light source emits in the wavelength range of between 100 nm and 400 nm.

In one embodiment, emulsion (E3) is exposed to a light source for a time of less than 15 minutes, preferably for 5 to 10 minutes.

At step d), the shell of the above-mentioned double droplets composed of photo-crosslinkable composition C2, is crosslinked and thereby converted to a viscoelastic polymeric shell encapsulating and protecting the water-soluble substance against release thereof in the absence of mechanical triggering.

In another embodiment, when composition C2 does not comprise a photoinitiator, step d) is a polymerization step without exposure to a light source, the length of time of this polymerization step d) preferably being between 8 hours and 100 hours and/or this step d) is conducted at a temperature of between 20° C. and 80° C.

In this embodiment, polymerization is initiated for example by exposure to heat (thermal initiation) or by mere contacting together of the monomers, polymers and reticulating agents, or with a catalyst. Polymerization time is then generally longer than several hours.

Preferably, polymerization step d) of composition C2 is carried out for a time of between 8 hours and 100 hours, at a temperature of between 20° C. and 80° C.

The composition obtained after step d), comprising solid microcapsules dispersed in composition C3, is ready for use and can be used without any additional post-treatment step of the capsules being required.

The present invention also relates to a plant protection composition comprising at least one solid cross-linked microcapsule as defined above.

The present invention also relates to the use of a solid cross-linked microcapsule as defined above, for reducing the volatility of clomazone.

The present invention also relates to a method for reducing the volatility of clomazone, comprising the encapsulation of clomazone into a solid cross-linked microcapsule as defined above.

According to an embodiment, in the method according to the invention, the release rate of clomazone is characterized by an exponential decay function N(t)=N₀ e^{-kt}, where the value of k varies from 0.6 to 1.3 for t=1 and from 0.3 to 0.7 for values of t>1, where t is measured in units of days, k is the rate of exponential decay and N₀ is the initial amount of clomazone.

The present invention also relates to a method for treating a plant, comprising the application onto said plant of a plant protection composition as defined above.

The present invention also relates to a weeding method comprising the application on the locus of a weed of a plant protection composition as defined above.

The capsules of the invention contain clomazone and are suitable for the preparation of agrochemical formulations. Therefore, a further aspect of the invention is a formulation containing the microcapsules disclosed herein. Said formulation comprises the microcapsules of the invention and at least one additive, for example, an agriculturally acceptable carrier that can be solid or liquid. The formulations may also contain one or more components to help improve the properties of the formulation. Any type of formulation containing capsules is suitable for the purposes of the present invention. For example, the formulation can be one selected from the group consisting of aqueous capsule suspensions (CS), and mixtures of CS formulations with other formulation types, for example, mixtures of CS formulations with aqueous suspension concentrates (EW) to form ZC formulations, or mixtures with oil-in-water emulsions to form ZW formulations, or mixtures with suspoemulsions (SE) to form ZE formulations. The previous is a non-limitative list of formulation types recognized by the Australian Pesticides and Veterinary Medicines Authority (https://apvma.gov.au/node/10901). Other formulation types including capsules may also be suitable.

A Capsule Suspension (CS) according to the present application is a stable suspension of capsules in a fluid, normally intended for dilution with water before use.

A ZC formulation according to the present application is a material comprising a suspension of fine particles of an active ingredient, combined with a suspension of the microcapsules of the invention in an aqueous phase together with suitable additives. A ZW formulation according to the present application is a material comprising an emulsion of fine droplets of an active ingredient in the form of the combination of a suspension of the microcapsules of the invention in an aqueous phase together with suitable additives. A ZE formulation according to the present application is a material comprising an emulsion of fine droplets of an active ingredient and a suspension of fine particles of the microcapsules of the invention in an aqueous phase, together with suitable additives.

It is a further aspect of the invention a method for the control of undesired plants (weeds) comprising contacting an effective amount of the microcapsules of the invention comprising clomazone with the locus (or the future expected locus) of said undesired plants.

As used herein, the terms “control” or “controlling” or “combatting” refer to preventing disease or the growth of unwanted plants, protecting plants from disease, delaying the onset of disease, and killing, or to reducing the deleterious effects of the disease, or to killing or to reducing growth of unwanted plants.

As used herein, the term “effective amount” refers to an amount of the microcapsules of the invention which is sufficient for controlling undesired plants on the locus of crop plants, including pasture, and does not cause any significant damage to the treated crop plants or pasture.

As used herein the term “plant” or “crop” or “crop plants” includes reference to whole plants, plant organs (e.g. leaves, stems, twigs, roots, trunks, limbs, shoots, fruits etc.), plant cells, or plant seeds, which have industrial interest, including grasslands and pastures, such as for example plants destined to human consumption, animal consumption or other industrial uses. This term also encompasses crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil. Crops according to the present invention include rangelands, grass pastures, forestry, as well as non-crop land and rights-of-way sites such as around industrial and military installations, railways, airports, under powerlines and along pipelines. As used herein, the term “crop” includes plants which have been modified by breeding, mutagenesis or genetic engineering. Genetically modified plants are plants in which their genetic material has been modified by the use of recombinant DNA techniques. Typically, one or more genes have been integrated into the genetic material of such a plant in order to improve certain properties of the plant.

As used herein, the term “locus” includes a habitat, breeding ground, plant, propagation material, soil, area, material or environment in which undesired plants or weeds are growing or may grow.

As used herein, the phrase “agriculturally acceptable carrier” means carriers that are known and accepted in the art for the formation of formulations for agricultural or horticultural use, preferably approved by the regulator for use in agriculture. Agriculturally acceptable carriers can be solid or liquid (solvents).

As used herein, the term “tank mix” or “tank mixture” means any dilution of a formulation before application in the field. Formulations are typically sold as concentrates that require dilution in water before application.

As used herein, the term “adjuvant” is used to designate components that are added to the tank-mix in order to improve one or more properties before application on the field. Adjuvants typically improve the miscibility of the formulation in water or the dispersibility. Some formulations can incorporate and adjuvant, the so called “built-in adjuvants”.

The present invention is also directed to tank mixtures comprising a formulation of the invention diluted in a liquid carrier, usually water. Said tank mixtures may optionally comprise an adjuvant.

The formulations containing the microcapsules of the invention can be prepared following known methods, e.g. by mixing the microcapsules with appropriate additional components (e.g. surfactants or carriers). In addition to liquid or solid carriers, the formulations comprising the microcapsules of the invention may comprise other usual additives known in the field of agrochemistry, for example, surfactants (or surface-active substances).

Liquid carriers can be water or organic solvents, for example, toluene or vegetable oils. Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in liquid formulations. Surface-active substances may be anionic, cationic, non-ionic or polymeric. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and dialkylphosphate esters.

Further additives that can be used in agrochemical formulations include crystallization inhibitors, viscosity modifiers, suspending agents, dyes, antioxidants, anti-foaming agents, light absorbers, mixing auxiliaries, antifoams, complexing agents, pH-modifying substances and buffers, corrosion inhibitors, fragrances, wetting agents, take-up enhancers, micronutrients, plasticizers, glidants, lubricants, dispersants, thickeners, antifreezes, microbicides, and liquid and solid fertilizers.

The rate at which the formulation containing the microcapsules of the invention is applied will depend upon the particular type of weed to be controlled, the degree of control required and the timing and method of application, as well as the particular crop (or non-crop area) involved. In general, the formulations of the invention can be applied at an application rate lying in the range of from about 1 gram of clomazone per hectare (g a.i./ha) to about 2 000 g a.i./ha, preferably from 5 g a.i./ha to about 200 g a.i./ha of clomazone. The skilled person will adapt the total amount of the herbicide applied to the specific situation and to the conditions. Typically, the herbicidal formulation according to the invention is applied at a rate lying in the range of from about 15 g a.i./ha to about 190 g a.i./ha, for example from about 30 g a.i./ha to about 180 g a.i./ha, even more particularly in the range of from about 70 g a.i./ha to about 150 g a.i./ha.

Exemplary weeds that can be controlled with he formulations of the invention are Barnyardgrass, Broadleaf Signalgrass, oxtail, goosegrass, panicum, Johnsongrass, cupgrass, field sandbur, Bermuda grass, red rice, itch grass, velvetleaf, spurred anoda, common ragweed, Jimsonweed, lambsquarter, Pennsylvania smartweed, prickly sida, purslane, redweed, Venice mallow, cocklebur, dayflower, Florida beggarweed, Florida pusley, Kochia, redvine, tropic croton, wild poinsettia, balloonvine, black nightshade, curly dock, joint vetch, shattercane, or morning glory.

The microcapsules of the invention can be formulated alone or in mixtures comprising further active ingredients in addition to clomazone. Alternatively, the formulation of the invention may comprise clomazone as only active ingredient and then be tank-mixed with further actives ingredients. Thus, the formulations of the invention may comprise the microcapsules containing clomazone as described herein and at least one additional agrochemical active ingredient, or be tank mixed with said at least one additional agrochemical active ingredient. Said at least one additional agrochemical active ingredient can be chosen from a herbicide, a fungicide or an insecticide, preferably a herbicide. Said herbicide may have the same or a different mode of action. Many times, it has a different mode of action in order to prevent weed resistance. Said at least one additional agrochemical active ingredient can be selected from the group consisting of ACCase inhibitors (Group 1), ALS inhibitors (Group 2), microtubule assembly inhibitors (Group 3), auxin mimics (Group 4), photosynthesis II (PS II) inhibitors (Group 5 and 6), EPSP synthase inhibitors (Group 9), glutamine synthetase inhibitors (Group 10), PDS inhibitors (Group 12), DOXP synthase inhibitors (Group 13), PPO inhibitors (Group 14), VLCFAs inhibitors (Group 15), DHP inhibitors (Group 18), Auxin transport inhibitors (Group 19), Photosyntesis I (PS 1) electron diversion (Group 22), microtubule organization inhibitors (Group 23), Uncouplers (Group 24), HPPD inhibitors (Group 27), cellulose synthesis inhibitors (Group 29), fatty acid thioesterase inhibitors (Group 30), serine threonine protein phosphatase inhibitors (Group 31), solanesyl diphosphate synthase inhibitors (Group 32), homogentisate solanesyltransferase inhibitors (Group 33), lycopene cyclase inhibitors (Group 34), and herbicides of unknown mode of action (Group 0). The numbers in parenthesis indicate the group number assigned by the HRAC (Herbicide Resistance Action Committee) to each family of modes of action.

For example, the formulation may comprise a VLCFA inhibitor, such as one selected from the group consisting from acetochlor, alachlor, amidochlor, butachlor, butenachlor, delachlor, diethatyl, dimethachlor, dimethnamid, ethachlor, ethaprochlor, ethofumesate, metazachlor, metolachlor, S-metolachlor, and pretilachlor; or an auxin mimic, such as one selected from the group consisting of aminopyralid, clopyralid, florpyrauxifen, halauxifen, picloram, chloramben, dicamba, dichlorprop, 2,4,5-T, 2,4-D, MCPA, 2,4-DB, MCPB, mecoprop, and clomeprop; or an ALS inhibitor, such as one selected from the group consisting of imazamethabenz, imazamox, imazapic, imazapyr, imazaquin, imazethapyr, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, monosulfuron-ester, nicosulfuron, orthosulfamuron, oxasulfuron, primisulfuron, propyrisulfuron, pyrazosulfuron, rimsulfuron, sulfometuron, sulfosulfuron, trifloxysulfuron, thiencarbazone, propoxycarbazone, flucarbazone, cloransulam, diclosulam, florasulam, flumetsulam, metosulam, and pyrosulam; or a photosynthesis II (PS II) inhibitor, such as one selected from the group consisting of ametryne, amicarbazone, atrazine, bentazon, bromacil, bromofenoxim, bromoxynil, chlorobromuron, chlorotoluron, chloroxuron, cyanazine, desmedipham, desmetryne, dimefuron, dimethametryne, diuron, ethidimuron, fenuron, fluometuron, hexazinone, ioxynil, isoproturon, isouron, lenacil, linuron, metamitron, methabenzthiazuron, metobromuron, metoxuron, metribuzin, monolinuron, neburon, pentanochlor, phenmedipham, prometon, prometryne, propanil, propazine, pyrazon (chloridazon), pyridafol, pyridate, siduron, simazine, simetryne, tebuthiuron, terbacil, terbumeton, terbuthylazine, terbutryne, and trietazine.

For example, the formulation may comprise a VLCFA inhibitor, such as one selected from the group consisting from acetochlor, dimethachlor, dimethnamid, ethofumesate, metazachlor, metolachlor, S-metolachlor, and pretilachlor; or an auxin mimic, such as one selected from the group consisting of aminopyralid, clopyralid, halauxifen, picloram, dicamba, 2,4-D, and MCPA; or an ALS inhibitor, such as one selected from the group consisting of imazamethabenz, imazamox, imazapic, imazapyr, imazaquin, imazethapyr, metsulfuron, tribenuron, mesosulfuron, nicosulfuron, thiencarbazone, and florasulam; or a photosynthesis II (PS II) inhibitor, such as one selected from the group consisting of amicarbazone, atrazine, bentazon, bromacil bromoxynil, diuron, hexazinone, ioxynil, isoproturon, metamitron, metribuzin, and propanil.

The term “a” or “an” as used herein includes the singular and the plural, unless specifically stated otherwise. Therefore, the terms “a,” “an” or “at least one” can be used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±5% from the indicated values in the range. In addition, the endpoints of all ranges directed to the same component or property herein are inclusive of the endpoints, are independently combinable, and include all intermediate points and ranges.

The expressions «between . . . and . . .», «from . . . to . . .» and «ranging from . . . to . . .» are to be construed as including the limits unless specified otherwise.

The following examples illustrate the present invention without limiting the scope thereof.

### EXAMPLES

### Example 1: Preparation of Microcapsules

A mechanical stirrer (Ika Eurostar 20) equipped with a deflocculating stirring propeller is used to carry out all the stirring steps.

### Step a): Creation of the Core of the Capsules (Dispersion of Particles—Composition C1) (all Percentages are in Mass %)

Clomazone 60%
Fumed silica 7%
Biodegradable carrier oil—complex ester oil (Priolube 1847) 33%

The core of the capsule is obtained by mixing the above components at RT until homogeneous, thereby obtaining C1.

### Step b): Preparation of the Shell Composition

### Shell Composition:

M1: aliphatic glycerol-modified polyester oligomer with acrylate terminal groups polyester comprising less than 3% of nitrogen by weight. 79%
M2: tri-acrylated monomer. 20%
Darocur 1173. 1%

The shell of the capsule is prepared by mixing the above components at RT until homogeneous, thereby obtaining C2.

The composition of the core C1 is added at RT to the composition of the shell C2 with a mixing rate of 100 rpm to produce the first emulsion E1. The ratio of the weight of the shell to the weight of the core is 40/60.

### Step c): Preparation of the Second Emulsion (E2)

Composition C3, the continuous phase, is produced from 8% cellulose derivative, and 92% water. The composition C3 is stirred at 2,000 rpm until complete homogenization. The first emulsion E1 is then added to the composition C3, which is then stirred at 2,000 rpm for 2 minutes at RT to obtain the second emulsion E2, at a ratio of E1:C3 of 10:90.

### Step e): Reticulation of the Capsule Envelope

The second emulsion (E2) obtained in the previous step is irradiated for 2 minutes with the aid of a UV light source (Dymax LightBox ECE 2000) having a maximum light intensity of 1 W/cm² at a waveform length of 385 nm.

The microcapsules were separated from their continuous phase by centrifugation at 2000 G for over 3 cycles for a total of 20 min.

Furthermore, the herbicidal efficacy of encapsulated clomazone according to the present invention was evaluated and shown to be higher than the prior art, while reducing volatility (see the biological examples below).

The solid microcapsules according to Example 1 thus prove to be particularly suitable for effectively encapsulating clomazone. These capsules comprise a solid polymer envelope that is an aliphatic co-polymer network comprising a minimum of 25% ester groups in weight.

### BIOLOGICAL EXAMPLES

TGA analysis after 2 weeks of storage at room temperature, 40° C. or 54° C. showed no degradation of the capsules as prepared according to example 1. Optical microscopy showed no visible oil, no broken capsules and no aggregation after 2 weeks at room temperature. Similar results were obtained after 2 weeks at 40° C. or 54° C., although some samples showed small aggregation; all samples were readily redispersed in all tests.

### Biological Example 1: Volatility

The volatility of clomazone in the microcapsules prepared according to Example 1 was tested as a slurry in water, and compared to existing commercial products. The experiment evaluated the bleaching effect of different treatments in wheat.

The composition and characteristics of the microcapsules according to the invention are summarized in Table 1.

TABLE 1

| | | (A) | (B) | (C) | (D) |
|---|---|---|---|---|---|
| | Clomazone | 9.5 | 8.0 | 15.0 | 14.8 |
| | wt. % | | | | |
| | Core:Shell | 40:60 | 40:60 | 60:40 | 60:40 |
| | (weight) | | | | |
| Shell | % of ester | 35.4 | 31.8 | 36.8 | 37.2 |
| Material | groups | | | | |
| | in shell | | | | |
| | Average | 408 | 447 | 402 | 389 |
| | MW of | | | | |
| | spacer | | | | |
| | between | | | | |
| | crosslinks | | | | |
| | (g/mol) | | | | |
| | Cross- | Low | Very low | High | Medium |
| | linking | | | | |
| | density | | | | |
| | of shell | | | | |
| Core | carrier oil | Complex | Complex | Complex | Complex |
| Material | (% weight) | Ester oil | Ester oil | Ester oil | Ester oil |
| | | (48.5%) | (48.5%) | (33%) | (33%) |
| | viscosifying | Fumed silica | Fumed silica | Fumed silica | Fumed silica |
| | agent | (3%) | (3%) | (7%) | (7%) |
| | (% weight) | | | | |
| | Viscosity of | 2000 ± 150 | 2000 ± 150 | 18500 ± 1500 | 18500 ± 1500 |
| | core at | | | | |
| | \dot{γ} = 10s⁻¹, | | | | |
| | 20° C. | | | | |
| | (mPa · s) | | | | |

The percentage of ester groups in the shell is defined as described above. For this purpose, the molecular weight of an ester group is considered as 58 g/mol. It will be clear to the person skilled in the art how this parameter can be derived from the chemical structure of the raw materials.

The cross-link density of polymers is defined as the density of the cross-link bonds in the polymer. The cross-link density of a polymer can be determined by using ASTM-D2765 as a method guideline.

The viscosity of the core is measured in the following manner: A solution comprising the core, i.e. the ester oil complex, the clomazone, and the fumed silica, was added to the measurement chamber of a rheometer, (Anton Paar MCR92) and was used to perform the measurements at 20° C. A shear of 1 s⁻¹ was applied using a plate geometry having 20 cm diameter, as the temperature was calibrated over 60 s. After calibration, an incremental shear was applied from 1-100 s⁻¹ every 0.1 s.

For the comparative examples, Centium 360 CS® (microencapsulated 360 CS Clomazone formulation) and unencapsulated clomazone 480 EC were used.

Sowing: 10 seeds per 7×7 cm pot or “Gedera” wheat, standard potting mix, fertilized with standard 20/20/20 NPK 40 ppm fertilizer solution once a week.

Trial guidelines: All the plants are sown at the same time and grown under the same conditions in the growth room to synchronize the plants age at the application timing, treated according to the timing and rate specified below and maintained in the growth room.

Each treatment was replicated 3 times by spraying solutions on Neve-Yaar soil placed in 90 mm Petri dishes using the calibrated track sprayer, equivalent to 300 L/ha. Then dried in the hood for 5 minutes. Pots with 9-days old wheat is placed in clear plastic cylinders tightly fitting the petri dishes and sealed with clear plastic bags. Then the whole setup is placed in the hood with high pressure sodium (HPS) lamp and maintained for 2 days at 14/10 hr light/dark photoperiod at 21-23° C., for the rest 5 days at regular high intensity LED growth lamps.

The application solutions were prepared at 1000% (FR×10) and 300% (FR×3) of the recommended field rate (120 g/Ha in 300 L/Ha). Volatility was tested by evaluating bleaching intensity 7 days after spraying (DAS_7 expressed as % control) according to a common evaluation key. The treatments are summarized in Table 2.

| Treatment | | | % recom- | |
|---|---|---|---|---|
| Number | | ×FR factor | mended dose | g/ha |
| 1 | 480EC non- | FR × 10 | 1000% | 1200 |
| | encapsulated | | | |
| | (Comparative) | | | |
| 2 | 480EC non- | FR × 3 | 333% | 400 |
| | encapsulated | | | |
| | (Comparative) | | | |
| 3 | Encapsulated 360CS | FR × 10 | 1000% | 1200 |
| | Centium 360 CS ® | | | |
| | (Comparative) | | | |
| 4 | Encapsulated 360CS | FR × 3 | 333% | 400 |
| | Centium 360 CS ® | | | |
| | (Comparative) | | | |
| 5 | (A) | FR × 10 | 1000% | 1200 |
| 6 | (A) | FR × 3 | 333% | 400 |
| 7 | (B) | FR × 10 | 1000% | 1200 |
| 8 | (B) | FR × 3 | 333% | 400 |
| 9 | (C) | FR × 10 | 1000% | 1200 |
| 10 | (C) | FR × 3 | 333% | 400 |
| 11 | (D) | FR × 10 | 1000% | 1200 |
| 12 | (D) | FR × 3 | 333% | 400 |
| 13 | Untreated | | | |

Bleaching was evaluated DAS_7 on all treatments by 2 independent testers as percentage of the maximum bleaching obtained with the 480EC comparative examples at FR×10. As shown in Table 3 (average of Tester No. 1 and Tester No. 2), all microcapsules according to the present invention (A, B, C and D) reduced the bleaching, indicating a reduction in volatility of clomazone, more than the comparative examples, even when compared with a commercial microcapsule formulation (Centium® 360 CS).

TABLE 3
Tester 1

| Treatment | | |
|---|---|---|
| description | FR × 3 | FR × 10 |
| C | 11.5 | 29 |
| A | 17 | 12.5 |
| D | 23 | 75 |
| B | 23.5 | 62 |
| 360CS | 36 | 85.5 |
| 480EC | 78 | 98.5 |

### Biological Example 2: Efficacy

Efficacy of the clomazone microcapsules according to the invention was tested using Centium 360 CS® (microencapsulated 360 CS Clomazone formulation) as comparative example. The microcapsules according to the invention were prepared according to Example 1 and tested as a slurry in water. The composition and characteristics of the microcapsules according to the invention are summarized in Table 4.

TABLE 4

| | | (E) | (F) |
|---|---|---|---|
| | Clomazone wt. % | 9.6 | 9.6 |
| Shell | Core:Shell | — | — |
| Material | (weight) | | |
| | Minimum % of | 37.2 | 36.8 |
| | ester groups in | | |
| | shell | | |
| | Average MW of | 389 | 402 |
| | spacer between | | |
| | cross-links | | |
| | (g/mol) | | |
| | Cross-linking | medium | High |
| | density of shell | | |
| | carrier oil | Complex | Complex |
| | (% weight) | Ester oil | Ester oil |
| | | (48.5%) | (48.5%) |
| Core | viscosifying agent | Fumed silica | Fumed silica |
| Material | (% weight) | (3%) | (3%) |
| | Viscosity of core | 2000 ± 150 | 2000 ± 150 |

Application timing of clomazone: Pre-emergence.

Method: Pot trial. Weeds—BBCH 0-7, were sprayed with rail sprayer at 200 I/ha.

Rates tested—40, 60, 80, 100 & 120 g A.i./ha.

Weed species tested: AMARE (Amaranthus retroflexus), ALOMY (Alopecurus myosuroides), LOLPE (Lolium perenne), and SOLNI (Solanum nigrum). All were evaluated 41 DAA except MATCH, which was evaluated at 31 DAA.

The efficacy over each weed was visually evaluated according to an evaluating key and given a score of 1 to 5, 1 meaning low efficacy and 5 meaning high efficacy. The results are provided in Table 5.

TABLE 5

| Weed | Centium ® | A | E | F | B |
|---|---|---|---|---|---|
| AMARE | 1 | 2 | 5 | 4 | 3 |
| ALOMY | 1 | 3 | 3 | 2 | 3 |
| LOLPE | 1 | 1 | 1 | 1 | 1 |
| SOLNI | 1 | 1 | 1 | 1 | 1 |
| Total | 4 | 7 | 10 | 8 | 8 |
| Improvement | | 75% | 150% | 100% | 100% |

For all weeds all microcapsules according to the invention performed as well or better than the reference. Overall, the capsules of the invention displayed better efficacy and lower volatility and phytotoxicity (see results in example 1).

The highest efficacy observed as in Sample E, which shows a strong correlation between efficacy and the molecular weight of the spacer in the cross-linked shell.

### Biological Example 3: Efficacy

Efficacy of the clomazone microcapsules according to the invention was tested using Centium 360 CS® (microencapsulated 360 CS Clomazone formulation) as comparative example. The microcapsules according to the invention were prepared according to Example 1 and tested as a slurry in water (capsules (C) and (D)).

Application timing of clomazone: Pre-emergence.

Method: Pot trial. Weeds—BBCH 0-7, were sprayed with rail sprayer at 200 I/ha.

Rates tested—40, 60, 80, 100 & 120 g A.i./ha.

Weed species tested: AMARE (Amaranthus retroflexus), ALOMY (Alopecurus myosuroides), LOLPE (Lolium perenne), SOLNI (Solanum nigrum), and MATCH (Matricaria recutita). All were evaluated 7, 14 and 21 DAA (days after application).

The efficacy over each weed was visually evaluated according to an evaluating key and given a score of 1 to 5, 1 meaning low efficacy and 5 meaning high efficacy. The overall results are provided in Table 6.

TABLE 6

| Weed | Centium ® | C | D |
|---|---|---|---|
| AMARE | 2 | 4 | 4 |
| ALOMY | 3 | 3 | 1 |
| LOLPE | 1 | 2 | 1 |
| SOLNI | 4 | 4 | 4 |
| MATCH | 1 | 4 | 3 |
| Total | 11 | 17 | 13 |
| Improvement | | 55% | 18% |

All microcapsules according to the invention have an overall performance equal to or better than the reference. Overall, the capsules of the invention display better efficacy and lower volatility and phytotoxicity (see results in example 1).

1. A solid cross-linked microcapsule encapsulating clomazone having a mean diameter from 3 μm to 30 μm, said microcapsule comprising:
a core consisting of a composition C1 comprising clomazone, and
a solid cross-linked polymer envelope totally encapsulating the core at its periphery, said solid cross-linked polymer envelope being made of a biodegradable cross-linked polymer, said polymer being an aliphatic polymer obtained by polymerizing one or several oligomer(s) or monomer(s), said polymer comprising at least 25% of ester groups by weight in comparison with the total weight of said polymer,
and wherein the average thickness of said solid cross-linked polymer envelope is from 5% to 30% of the average diameter of said solid cross-linked microcapsule.

2. The solid cross-linked microcapsule of claim 1, wherein the composition C1 further comprises from 1% to 20% by weight of a viscosifying agent relative to the total weight of said composition C1.

3. The solid cross-linked microcapsule of claim 2, wherein the viscosifying agent is selected from the group consisting of: fumed silica, clay, organic polymers, and hydrogels or hydrophilic silicates.

4. The solid cross-linked microcapsule of claim 1, wherein the composition C1 further comprises from 5% to 40% by weight of a biodegradable carrier oil relative to the total weight of said composition C1.

5. The solid cross-linked microcapsule of claim 4, wherein the composition C1 comprises from 5% to 30% by weight of a biodegradable carrier oil relative to the total weight of said composition C1.

6. The solid cross-linked microcapsule of claim 4, wherein the biodegradable carrier oil is selected from the polyester oils.

7. The solid cross-linked microcapsule of claim 1, wherein the composition C1 comprises from 20% to 60% by weight of clomazone relative to the total weight of said composition C1.

8. The solid cross-linked microcapsule of claim 1, wherein the aliphatic polymer of the solid cross-linked polymer envelope is obtained by polymerizing one or several oligomer(s) or monomer(s) M1 and M2, the molecular weight of M1 being from 1,500 to 10,000 g/mol and the molecular weight of M2 being from 50 to 1,500 g/mol.

9. The solid cross-linked microcapsule of claim 1, wherein the solid cross-linked polymer envelope is formed through UV polymerization.

10. The solid cross-linked microcapsule of claim 1, being devoid of surfactant.

11. The solid cross-linked microcapsule of claim 1, further comprising lignosulfonate.

12. A plant protection composition comprising at least one solid cross-linked microcapsule according to claim 1.

13. (canceled)

14. A method for reducing the volatility of clomazone, comprising the encapsulation of clomazone into a solid cross-linked microcapsule according to claim 1.

15. The method of claim 14, wherein the release rate of clomazone is characterized by an exponential decay function N(t)=N₀ e^{-kt}, where the value of k varies from 0.6 to 1.3 for t=1 and from 0.3 to 0.7 for values of t>1, where t is measured in units of days, k is the rate of exponential decay and N₀ is the initial amount of clomazone.

16. A weeding method comprising the application on the locus of a weed of a plant protection composition according to claim 12.
